(19) United States
(12) Patent Application Publication
(10) Pub. No.: US 2022/0351212 A1
(43) Pub. Date: Nov. 3, 2022

(54) DYNAMIC SECURITY CODE

(71) Applicant: Goldman Sachs & Co. LLC, New York, NY (US)

(72) Inventors: Yoohyun Sung, Jersey City, NJ (US); Thomas E. Whitford, Newark, DE (US); Tom Gunnar Sjoberg, New York, NY (US); Raphael Shorser, Oakland, CA (US); Anukrati Bhandari, Jersey City, NJ (US)

(21) Appl. No.: 17/725,954

(22) Filed: Apr. 21, 2022

Related U.S. Application Data
(60) Provisional application No. 63/177,737, filed on Apr. 21, 2021.

(51) Int. Cl. G06Q 20/40; G06F 21/33; G06F 21/57

(52) U.S. Cl. CPC G06Q 20/4016; G06F 21/33; G06F 21/577; G06F 2221/033

(57) ABSTRACT

A system and method are disclosed for determining when to update and updating dynamic security codes. A user's payment information (e.g., credit card information) includes a dynamic security code that may be updated after a threshold amount of time passes or after successful transactions made using the dynamic security code. The time at which an update is made may be used to generate the updated dynamic security code. A user may specify a dynamic security code associated with the user's payment information (e.g., credit card information) while requesting a transaction be made with the user's credit card. A record of previously generated dynamic security codes is maintained. The transaction may be authorized based on whether the user-specified dynamic security code matches any of the current or previously generated dynamic security codes.

### CROSS REFERENCE TO RELATED APPLICATIONS

This application claims the benefit of U.S. Provisional Application No. 63/177,737, filed Apr. 21, 2021, which is incorporated by reference in its entirety.

### TECHNICAL FIELD

The disclosure generally relates to digital information security and, more specifically, dynamic generation of authentication codes for authorizing transactions.

### BACKGROUND

The popularity of online transactions and introduction of digital wallets have increased the demand for improved digital information security. Sensitive payment information such as credit card numbers, expiration dates, and security codes may be stolen because of phishing attempts, malware that records keystrokes made during online purchases, public or unsecured internet connections, or data breaches. Identity theft is a problem that may be perpetuated with digital wallets that provide yet another target for thieves. the authenticity of transaction requests may be difficult to verify when sensitive payment information is digital and transactions may be made remotely (i.e., without in-person identity verification). Thus, an approach for improving the security of payment information (e.g., in digital wallets) for authorizing transactions is needed.

### SUMMARY

A system and method are disclosed for updating dynamic security codes (e.g., when and how to update the dynamic security codes). To access payment information to make a purchase with a merchant, a user may access a software application on a user device (e.g., a digital wallet on a mobile phone). An issuer system may issue a payment tool (e.g., a credit card) to the user and provide a current dynamic security code to the user's mobile phone via the digital wallet application upon the user's request. The user specifies payment information, including a dynamic security code, to be provided to the merchant to complete a transaction with the merchant. The user-specified dynamic security may or may not match the current dynamic security code (e.g., the user has typed the code incorrectly). The merchant may communicate the user-specified payment information to a transaction processing system which operates with the issuer system to approve or reject the requested transaction and generate an updated dynamic security code.

The authorization decision to approve or reject the user-requested transaction may include two decisions: a provisional and a final authorization decision. The transaction authorization system determines a provisional authorization decision, which may include a comparison of the user-specified dynamic security code and a verified dynamic security code. If the codes do not match, the transaction authorization system may request that the issuer system determine a final authorization decision. The issuer system maintains a record of previously generated dynamic security codes that were verified for use by the user. The previously generated codes may be expired. That is, expired codes are unusable for any authorization decision. Alternatively, the previously generated codes are not current but not yet expired. That is, unexpired codes are useable for authorization decisions, subject to further fraud prevention measures.

The issuer system may compare the user-specified dynamic security code to the previously generated dynamic security codes to determine the final authorization. If the user-specified dynamic security code matches an unexpired dynamic security code, the issuer system may approve the transaction as the final authorization decision. In some embodiments, determining the final authorization decision further includes determining a risk score based on one or more factors or rule checks (e.g., determining if the user-specified dynamic security code was generated more than a threshold period of time ago, where the security risk increases if the generation occurred beyond the threshold period of time). The transaction processing system may then communicate to the merchant that the payment information has been verified and the transaction request has been approved.

The issuer system may determine when a dynamic security code should be updated. The issuer system may determine whether a time since the current dynamic security code was generated exceeds a threshold amount of time (e.g., twelve hours). If more than twelve hours has passed since the current security code was generated, the issuer system may initiate a rotation of the dynamic security codes, which includes instructing the transaction processing system to generate a new code, replacing the current dynamic security code with the updated dynamic security code, and storing the unexpired, but not current, dynamic security code in a database of previously generated dynamic security codes. The transaction processing system may generate an updated dynamic security code using a dynamic, changing value such as the current timestamp. The updated dynamic security code is provided to the issuer system for storage and subsequent access by the user.

Using a dynamic value to generate a dynamic security code may increase the security of the dynamic security code. A conventional transaction authorization system may use only static, unchanging values such as a credit card number or an expiration date to generate a static security code. If the algorithm used to generate the static security code is compromised, the dynamic security code may be determined and the user's payment information may be stolen. By using a dynamic value, a compromised algorithm cannot be exploited to determine a dynamic security code unless the dynamic value is known as well.

Furthermore, updating the dynamic security code after a threshold amount of time such as twelve hours rather than a short amount of time such as one minute improves the user experience of accessing payment information for purchases while preventing the dynamic security code from becoming stale. For example, a user is not pressured to finish submitting payment information within the minute before the dynamic security code expires because the dynamic security code will not be updated until at least twelve hours has passed. Additionally, the user may feel confident that, even if the dynamic security code is stolen by an identity thief, a new dynamic security code will be generated within twelve hours.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a transaction environment in which the techniques described may be practiced, according to one embodiment.

FIG. 2 is a block diagram of an issuer system and a transaction processing system in the transaction environment of FIG. 1, according to one embodiment.

FIG. 3 illustrates interactions that take place within the transaction environment of FIG. 1, according to one embodiment.

FIG. 4 is a flow diagram of a process for processing transactions using dynamic security codes, according to one embodiment.

FIG. 5 is a block diagram illustrating components of an example machine able to read instructions from a machine-readable medium and execute them in a processor.

### DETAILED DESCRIPTION

The Figures and the following description describe certain embodiments by way of illustration only. One skilled in the art will readily recognize from the following description that alternative embodiments of the structures and methods may be employed without departing from the principles described. Wherever practicable, similar or like reference numerals identify similar or identical structural elements or identify similar or like functionality.

Throughout the following description, the terms “dynamic security code,” “security code,” and “code” may be used interchangeably unless another meaning is apparent from the context. For example, where a static security code is described, the terms “dynamic security code” and “static security code” are used to promote clarity. As referred to herein, a “current dynamic security code” or “active dynamic security code” refers to a dynamic security code that is currently verified for use (i.e., unexpired) and is the most recently generated dynamic security code.

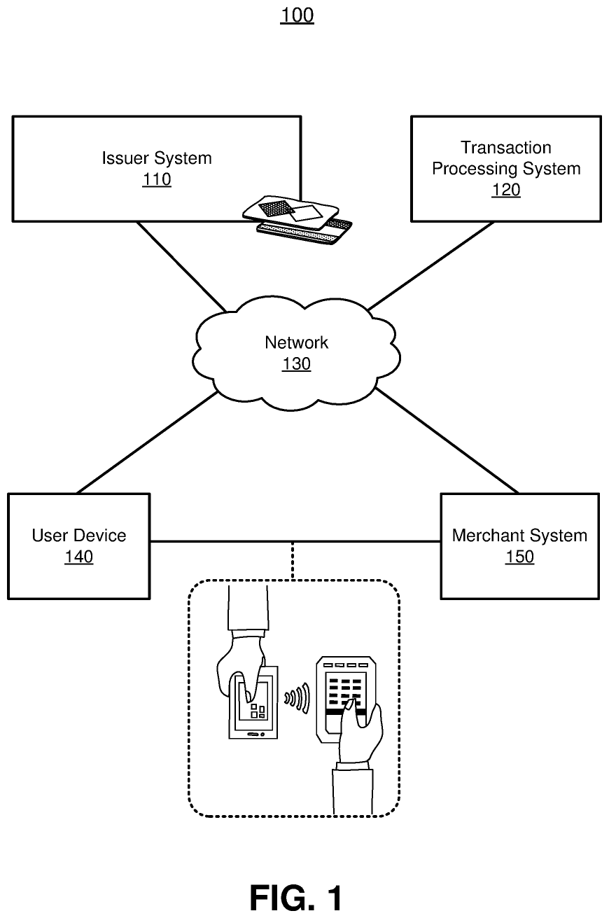

FIG. 1 illustrates a transaction environment 100 in which the techniques described may be practiced, according to one embodiment. The transaction environment 100 includes an issuer system 110, a transaction processing system 120, a network 130, a user device 140, and a merchant system 150. In alternative configurations, different or additional components may be included in the transaction environment 100. For example, the merchant system 150 may communicate with a third-party financial institution which routes requested transactions to an issuer system different from the issuer system 110 depicted. In some embodiments, components in the transaction environment 100 may function together as one component. For example, the functions of the transaction processing system 120 described below may be performed by the issuer system 110.

The issuer system 110 issues custom payment tools to be used on user devices (e.g., the user device 140). A custom payment tool is a physical or digital tool for making a payment using custom payment information associated with each custom payment tool. For example, a digital credit card may be a custom payment tool issued by the issuer system 110 that is made available for use on the user device 140 through the network 130. Each custom payment tool issued by issuer system 140 may be unique to its user and may be characterized by custom payment information. Custom payment information may be any set of alphanumeric data used to identify the user of the custom payment tool and the issuer system 110. Examples of custom payment information includes a credit card identification number, an expiration date, and a dynamic security code.

A dynamic security code, as referred to herein, is a card security code that is updated over time (e.g., periodically or upon conditions being met). The issuer system 110 may determine when to update dynamic security codes. For example, the issuer system 110 determines that a threshold amount of time has passed since the last dynamic security code was generated and will trigger instructions to the transaction processing system 120 to generate an updated dynamic security code. The issuer system 110 may determine to update a dynamic security code responsive to detecting a system event has occurred. As referred to herein, a “system event” may include any operational change to the issuer system 140 (e.g., a software update changing an algorithm used to determine the final authorization decision) or any suitable detectable event. For example, the issuer system 110 may detect changes to market data, which may include price and trade-related data for a financial instrument reported by a trading venue such as a stock exchange.

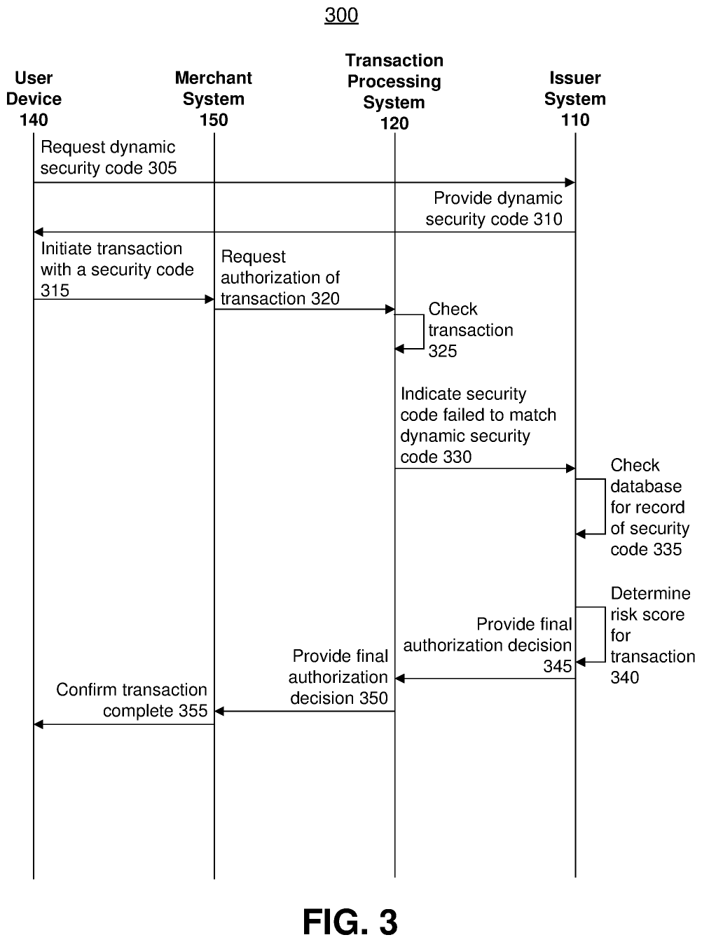

In some embodiments, the user device 140 may determine when to update dynamic security codes. For example, the user device 140 may receive user input requesting an updated dynamic security code and subsequently transmit a request to the transaction processing system 120 to generate the updated dynamic security code. In another example, the user device 140 may have the functionality of the issuer system 110, interacting with the transaction processing system 120 in place of or in addition to the issuer system 110 to authorize a transaction and/or to update a dynamic security code. Such functionality as performed by the user device 140 is further described in the description of FIG. 3.

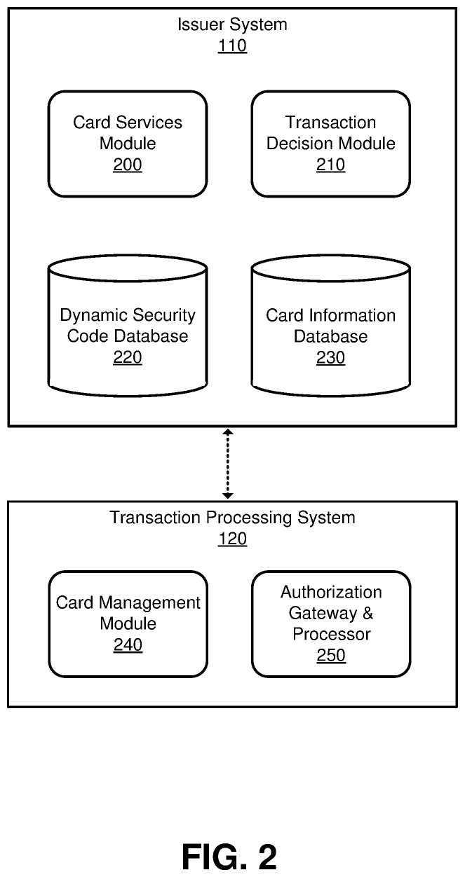

In some embodiments, to authorize a transaction made using custom payment information, the issuer system 110 determines a final authorization decision after the transaction processing system 120 makes a provisional authorization decision. Both a provisional authorization decision and a final authorization decision may be approvals or rejections of a user's attempt to use custom payment information to complete a purchase. The provisional and final authorization decisions do not necessarily need to agree in order for a transaction to be approved or rejected. The final authorization decision may be weighted greater than the provisional authorization decision. In some embodiments, a final authorization decision overrides a provisional authorization decision. Additionally or alternatively, the issuer system 110 may rely upon the provisional authorization decision as the final authorization decision. The issuer system 110 is described in further detail in the description of FIG. 2.

The transaction processing system 120 determines provisional authorization decision for transactions attempted using custom payment tools issued by the issuer system 100. In one embodiment, the provisional authorization decision is determined by comparing custom payment information that is specified by a user requesting a transaction and custom payment information that has been verified by the issuer system 110. After determining the provisional authorization decision, the transaction processing system 120 may transmit a request to the issuer system 110 for a final authorization decision. The transaction processing system 120 may use the final authorization decision to provide the merchant system 150 with an approval or rejection of the transaction initiated by the user device 140.

In some embodiments, the transaction processing system 120 may determine a stand-in transaction decision without a final authorization decision from the issuer system 110. For example, the transaction processing system 120 may use one or more fraud prevention measures such as purchase pattern detection, reverse IP address checks, or an address verification system. The issuer system 110 may determine a stand-in transaction decision that the transaction processing system 120 is authorized to use to determine without the final authorization decision from the issuer system 110. For example, the issuer system 110 may establish a rule that the stand-in transaction decision includes purchase pattern detection for fraud checks.

In some embodiments, the transaction processing system 120 generates dynamic security codes, including updated dynamic security codes (e.g., upon request by the issuer system 110). Once the dynamic security code is generated, the transaction processing system 120 may transmit the generated code to the issuer system 110 for storage. The transaction processing system 120 is described in further detail in the description of FIG. 2

The network 130 may serve to communicatively couple the issuer system 110, the transaction processing system 120, the user device 140, and the merchant system 150. Communication via the network 130 may comprise any combination of local area and/or wide area networks, using wired and/or wireless communication systems. In some embodiments, the network 130 uses standard communications technologies and/or protocols. For example, the network 130 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 110 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 130 may be represented using any suitable format, such as hypertext markup language (HTML) or extensible markup language (XML). In some embodiments, all or some of the communication links of the network 130 may be encrypted using any suitable technique or techniques.

The user device 140 is a computing device capable of receiving user input as well as transmitting and/or receiving data via a network. In some embodiments, the user device 140 is a conventional computer system, such as a desktop or a laptop computer. Alternatively, the user device 140 may be a device having computer functionality, such as a smartphone, tablet, personal computer, personal digital assistant (PDA), laptop, mobile telephone, or another suitable device. The user device 140 is configured to communicate with the issuer system 110 via the network 130, for example, using a native application executed by the device or through an application programming interface (API) running on a native operating system of the client device, such as IOS® or ANDROID™. In another example, the user device 140 is configured to communicate with the issuer system 110 via an API running on the issuer system 110. The user device 140 may store custom payment information (e.g., a digital credit card information). In some embodiments, the user device 140 may provide the custom payment information to the merchant system 150 to complete a transaction. The user device 140 may transmit the custom payment information indirectly (e.g., over the network 130) or directly (e.g., using Near Field Communication (NFC)). The custom payment information may be provided to the merchant system 150 automatically or manually by a user of the user device 140. For example, the user may need to manually enter an expiration date and security code of the digital credit card on a webpage hosted by the merchant system 150.

The merchant system 150 offers goods or services for purchase by the user of user device 140. The merchant system 150 may be communicatively coupled with the user device 140 and the transaction processing system 120 via the network 130 to receive and complete a transaction initiated by the user device 140. In some embodiments, the merchant system 150, within the transaction environment 100, includes a sub-environment of entities or merchant devices. For example, the merchant system 150 may include a point-of-sale device at a merchant's store that is communicatively coupled to the network 130 to communicate with the merchant's bank within the sub-network. The merchant system 150 may provide a response to the transaction request from the user device 140 either directly (e.g., using NFC) or indirectly (e.g., over the network 130). The response may be predicated on the authorizations decisions of the issuer system 110 and the transaction processing system 120. The merchant system 150 may provide user-specified custom payment information received in a transaction request to the systems 110 and 120 to allow them to make authorization decisions.

While the issuer system 110 is depicted as located remotely from the user device 140 (e.g., the issuer system 110 is on a remote computer server), the issuer system 110 may be hosted and executed on the user device 140. The components of the issuer system 110, as described further in the description of FIG. 2, such as software modules for determining final authorization decisions and memory for storing current dynamic security codes, may be hosted at the user device 140. The functionality of the user device 140 in the rotation of dynamic security codes is further described in the description of FIG. 3.

FIG. 2 is a block diagram of the issuer system 110 and the transaction processing system 120, according to one embodiment. The issuer system 110 and the transaction processing system 120 may be independently operating systems that communicate over the network 130 or within one system (e.g., the issuer system 110 encompasses the transaction processing system 120). As depicted in FIG. 2, the dashed line connecting the issuer system 110 and the transaction processing system 120 represents the communication between modules of both systems 110 and 120 in either separate or combined operating formats.

The issuer system 110 includes various modules and databases: the card services module 200, the transaction decision module 210, the dynamic security code database 220, and the card information database 230. In alternative configurations, different and/or additional components may be included in the issuer system 110. For example, the issuer system 110 may include an additional module that verifies the identity of users who request custom payment information stored in the card information database 230. In some embodiments, components in the issuer system 110 may function together as one component. For example, the dynamic security code database 220 and the card information database 230 may be a single database rather than two, separated databases.

The card services module 200 responds to requests from both the user device 140 and the transaction processing system 120. In some embodiments, the card services module 200 provides custom payment information to the user device 140 in response to receiving a request from the user device 140 for the information. For example, a user accesses a payment application on the user device 140, a mobile device, to pay for a purchase using the user's credit card information. The user device 140 may have verified the user's identity (e.g., by providing a password, using biometric identification, etc.) before sending the request to the issuer system 110 for the sensitive, custom payment information. The card services module 200 retrieves the custom payment information, as requested, from the card information database 230. The retrieved custom payment information may include a current dynamic security code (i.e., a dynamic security code verified for use in a transaction at the current time). The retrieved information is then transmitted to the user device 140 for use by the user in a transaction.

In some embodiments, the card services module 200 instructs the card management module 240 to generate an updated dynamic security code. The card services module 200 may transmit these instructions after the transaction decision module 210 authorizes a transaction involving a current dynamic security code, thereby initiating an update of the current dynamic security code. Additionally, or alternatively, the card services module 200 may determine when to generate an updated dynamic security code based on a threshold amount of time since the current dynamic security code was generated. The threshold amount of time may be within a range of 12 to 48 hours. In this way, the dynamic security code is not regenerated too quickly, hurrying a user to use the active code before it expires, or too slowly, exposing the user to security risks. For example, the card services module 200 may determine that at least 12 hours has passed since the current dynamic security code was generated and instruct the card management module 240 to generate an updated dynamic security code. In some embodiments, the card services module 200 may set a frequency at which the dynamic security codes are to be updated. The card services module 200 may determine to update a dynamic security code responsive to detecting a system event has occurred. For example, the card services module 200 may detect changes to market data and determine to update the dynamic security code. The card services module 200 may receive the updated dynamic security code from the card management module 240 and store the updated dynamic security code within the card information database 230.

The transaction decision module 210 determines a final authorization decision to either approve or reject a user's requested transaction. In some embodiments, the transaction decision module 210 receives a provisional authorization decision determined by the authorization gateway and processor 250. If the provisional authorization decision indicates the transaction request is approved, the transaction decision module 210 may perform a different series of checks than performed by the authorization gateway and processor 250 to further verify the transaction request should be approved. For example, the transaction decision module 210 may perform one or more fraud checks against information related to the user's requested transaction such as the user-specified payment information. The transaction decision module 210 can thus further verify that the transaction request should be approved. This way, the issuer system 110 further manages the processing of transactions made using its issued custom payment tools.

The transaction decision module 210 may evaluate user-specified payment information provided during the transaction request. For example, the transaction decision module 210 may determine that the user-specified dynamic security code does not match the current dynamic security code. Rather than determine a final authorization decision that indicates that the user's requested transaction has been rejected, the transaction decision module 210 may check the dynamic security code database 220 and determine whether the user-specified dynamic security code is among the previously generated dynamic security codes stored within the dynamic security code database 220.

The transaction decision module 210 may determine a risk score for the transaction. The determination of the risk score may involve the result of the check for whether the user-specified dynamic security code is within the dynamic security code database 220. The risk score may be a weighted score of the results from various rule checks, which may include the results of rule checks performed by the authorization gateway and processor 250 in its determination of a provisional authorization decision. In one embodiment, a risk score is dependent on a rule check involving the time since the current dynamic security code was generated. For example, the transaction decision module 210 may weigh a user-specified security code that was generated over a threshold period of time higher than a user-specified security code that was generated less than the threshold period of time. If the threshold period of time is 48 hours, a dynamic security code generated a week earlier is associated with a higher security risk than a dynamic security code generated a day ago. In another embodiment, the transaction decision module 210 may weigh the presence of the user-specified dynamic security code higher than the mismatch between the user-specified and current dynamic security codes. This may result in a risk score that exceeds a predetermined threshold for approving a transaction. The final authorization decision may then indicate that the transaction request has been approved. In some embodiments, the transaction decision module 210 distributes the final authorization decision to other modules of the issuer system 110 (e.g., the card services module 200) to initiate a rotation of the dynamic security code or update the dynamic security code history with an updated dynamic security code. Determining a risk score may, in addition or as an alternative to using the dynamic security code, involve checking if the user is on a blocked list or if the user's account is gray listed for suspicious activity (e.g., payment activity).

The dynamic security code database 220 stores dynamic security codes that were previously generated by the transaction processing system 120. Each dynamic security code stored within the dynamic security code database 220 is associated with a user having a custom payment tool issued by the issuer system 110. In some embodiments, the dynamic security codes stored within the dynamic security code database 220 are hashed or encrypted.

The card information database 230 stores custom payment information for users to whom the issuer system 110 has issued custom payment tools. The custom payment information may include credit card numbers, expiration dates, and current dynamic security codes for each custom payment tool, or any other suitable information for identifying the issuer system 110 and the user. In some embodiments, current dynamic security codes are stored in the dynamic security code database 220 rather than in the card information database 230. Alternatively, the contents of the dynamic security code database 220 and the card information database 230 may be stored within one database rather than separated as depicted in FIG. 2.

The transaction processing system 120 includes the card management module 240 and the authorization gateway and processor 250. In alternative configurations, different and/or additional components may be included in the transaction processing system 120.

The card management module 240 generates dynamic security codes. For example, the card management module 240 may generate an updated dynamic security code after receiving instructions to do so from the card services module 200. The dynamic security code may be generated using one or more of a credit card number, expiration of the credit card, or a timestamp. For example, the dynamic security code may be the result of a hash algorithm against static values such as a credit card number or an expiration of the credit card and dynamic values such as a timestamp of the time at which the generation occurs or at which a final authorization decision is made (e.g., measured using Unix time). By using a dynamic value to generate the dynamic security code, the card management module 230 may increase the likelihood that successive, generated dynamic security codes are different from one another. The card management module 240 may transmit the generated dynamic security code to the issuer system 110 for storage within the card information vault 230, replacing the previous, current dynamic security code. The card services module 200 may then store the unexpired, but not current, dynamic security code within the dynamic security code database 220, completing a rotation of security codes.

The authorization gateway and processor 250 determines a provisional authorization decision. To determine this provisional authorization decision, the authorization gateway and processor 250 may perform various rule checks. These rules may involve comparisons of user-specified information and verified payment information. The authorization gateway and processor 250 may obtain verified information from the issuer system 110 (e.g., from the card information database 230). The authorization gateway and processor 250 may then compare the dynamic security code obtained from the card information database 230 against the user-specified dynamic security code. If the codes do not match, the authorization gateway and processor 250 may determine a provisional authorization decision indicating that the transaction request is rejected. The authorization gateway and processor 250 may provide the provisional authorization decision to the transaction decision module 210.

FIG. 3 illustrates the interactions 300 that take place within the transaction environment 100 of FIG. 1, according to one embodiment. The user device 140 interacts with the issuer system 110 to receive custom payment information to use in transactions it requests with the merchant system 150. The merchant system 150 interacts with the transaction processing system 120 to verify user-specified payment information for the transaction request. The transaction processing system 120 and the issuer system 110 determine whether the transaction request should be approved or rejected. In parallel, the transaction processing system 120 and the issuer system 110 update a dynamic security code for use by the user device 140 in future transactions. In some embodiments, the interactions illustrated in FIG. 3 involve additional, fewer, or different functions or entities for performing the functions. For example, the functions of the transaction processing system 120 may be performed by the issuer system 110. The interactions of FIG. 3 may be facilitated by communication over network 130.

The user device 140 requests 305 custom payment information, including a dynamic security code, to make a purchase. The user device 140 may be a smartphone and the user may open a mobile application to retrieve the custom payment information (e.g., a digital wallet application). The request is transmitted to the issuer system 110. The issuer system 110 may prompt the user of the user device 140 to verify the user's identity before providing 310 the custom payment information. Alternatively, the user device 140 may have verified the user's identity prior to requesting 305 the dynamic security code. For example, login credentials associated with an account with the issuer system 110 may be provided to the mobile application prior to the request 305 being made. The issuer system 110 may retrieve custom payment information associated with the account from the card information database 230. The issuer system 110 then provides 310 the custom payment information, including the current dynamic security code, to the user device 140.

The user device 140 initiates 315 a transaction with the merchant system 150 using a user-specified security code. The merchant system 150 may include an online retailer to which the user provides custom payment information to purchase an item. An incorrect dynamic security code may be provided to the merchant system 150 during the transaction initiation 315. For example, an inactive dynamic security code may be provided by mistake by the user (e.g., via a typo). The merchant system 150 receives the user-specified custom payment information, including the incorrect dynamic security code and otherwise accurate custom payment information of the user's account. The merchant system 150 requests 320 authorization of the transaction from the transaction processing system 120, the request 320 including the user-specified custom payment information.

The transaction processing system 120 checks 320 the transaction. The authorization and gateway processor 250 checks 320 the transaction against one or more rules, including checking whether the user-specified dynamic security code matches the current security code. Because the incorrect dynamic security code was provided to the merchant system 150, the transaction processing system 120 determines a provisional authorization decision that the user-specified security code failed to match the current dynamic security code. The transaction processing system 120 provides 330 an indication to the issuer system 110 (e.g., via the provisional authorization decision) that there is a mismatch in security codes.

The issuer system 110 then determines a final authorization decision for the transaction. The issuer system 110 may check 335 the dynamic security code database 220 in response to the user-specified security code not matching the current dynamic security code. In particular, the transaction decision module 210 may check the dynamic security code database 220 for a previously generated dynamic security code that matches the user-specified security code. The transaction decision module 210 may determine 340 a risk score for the transaction. The determined risk score may meet a predetermined threshold for approving a transaction, and the issuer system 110 provides 345 the final authorization decision indicating this approval.

The transaction processing system 120 receives this final authorization decision and provides 350 the final authorization decision to the merchant system 150. Although not depicted, the merchant system 150 may then complete the transaction with one or more of the issuer system 110 or transaction processing system 120, causing the user's account to reflect goods purchased. With the transaction complete, the merchant system 150 confirms 355 with the user device 140 that the transaction is complete.

In some embodiments, although not depicted in FIG. 3, the transaction processing system 120 may update the dynamic security code in response to instructions provided by the issuer system 110 to initiate an update. Alternatively, the transaction processing system 120 can generate an updated dynamic security code and provide the updated dynamic security code to the issuer system 110. In some embodiments, the issuer system 110 may determine to update dynamic security codes according to a predetermined frequency. For example, the dynamic security code may be updated every twelve hours from when the dynamic security code was initially generated or twice daily at specific hours such as midnight and noon Greenwich Mean Time. In some embodiments, the issuer system 110 instructs the transaction processing system 120 to generate the updated dynamic security codes after at least a threshold amount of time has passed. For example, the issuer system 110 may check whether the threshold amount of time has passed in response to a user requesting payment information or using the payment information to fulfill a transaction. If the threshold amount of time (e.g., 12 hours) has passed, the issuer system 110 may initiate the update of the dynamic security code. The issuer system 110 can store the updated dynamic security code within the card information database 230 and store the previous dynamic security code in the dynamic security code database 220 for future authorization decision determinations. In some embodiments, the updated dynamic security code may be provided or stored before or after the final authorization decision is provided 350.

While the process 300 is described herein as involving an issuer system 110 that is separate from the user device 140 (e.g., located on a remote server), the issuer system 110 may be hosted and executed on the user device 140. For example, the rotation of dynamic security codes may be triggered by the user device 140. The transaction processing system 120 may perform a provisional authorization decision indicating 330 to the user device 140 that the security code failed to match the dynamic security code. The user device 140 may check 335 its local memory for previously generated, unexpired security codes and determines 340 a risk score to provide 345 a final authorization decision to the transaction processing system 120. This way, the user device 140 triggers a rotation of a dynamic security code by providing the final authorization decision, which may additionally be triggered based on a time since the current security code was generated.

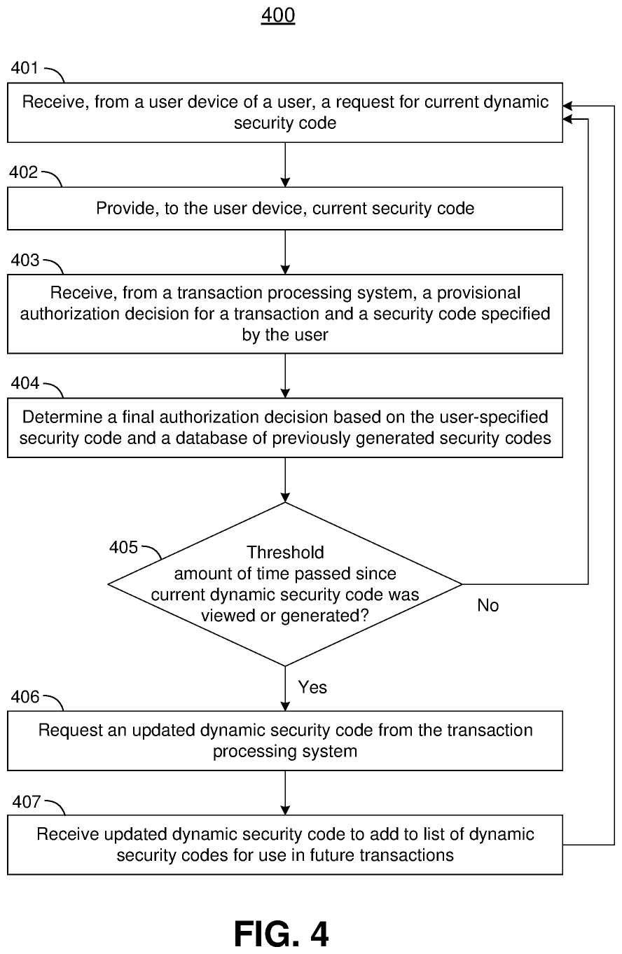

FIG. 4 is a flow diagram of a process 400 for processing transactions using dynamic security codes, according to one embodiment. The process 400 may be performed by the issuer system 110. While the process 400 shows a threshold time as being a condition for initiating the generation of an updated dynamic security code, other conditions may be considered. For example, a final authorization decision from the issuer system 110 may cause the process 400 to proceed from determining 404 a final authorization decision to requesting 406 an updated dynamic security code. Additionally or alternatively, the dynamic security code may be updated automatically based on a frequency (e.g., predetermined by the issuer system 110).

The issuer system 110 receives 401 a request from a user device of a user (e.g., the user device 140) for a current dynamic security code. The issuer system 110 fulfills this request by providing 402 the current security code to the user device. The issuer system 110 receives 403 a provisional authorization decision from a transaction processing system (e.g., the transaction processing system 120). The received provisional authorization decision may be for a transaction initiated by the user, who specifies a dynamic security code to complete the transaction. The provisional authorization decision may be received with a request for the issuer system 110 to generate a final authorization decision.

The issuer system 110 determines 404 the final authorization decision based on the user-specified dynamic security code and a database of previously generated dynamic security codes (e.g., the dynamic security code database 220). For example, the issuer system 110 may determine a final authorization decision based on the user-specified dynamic security code being a previously generated dynamic security code. The issuer system 110 determines 405 whether a threshold amount of time has passed since the current dynamic security code was viewed on the user device or since the current dynamic security code was generated. If a threshold amount of time has not passed (e.g., the current dynamic security code was generated less than 12 hours ago), the process 400 may maintain the current dynamic security code as the active code and wait to receive 401 a future request for the current dynamic security code. Otherwise, if a threshold amount of time has passed, the process 400 may proceed to initiating the generation of an updated dynamic security code.

The issuer system requests 406 an updated dynamic security code from the transaction processing system 120. The transaction processing system 120 generates the updated dynamic security code, as described with respect to the description of FIG. 2. The issuer system then receives 407 the updated dynamic security code from the transaction processing system 120 and adds the updated code to a list of dynamic security codes that can be used in future transactions. Alternatively, the issuer system may replace the current dynamic security code. For example, the current dynamic security code that is stored in the card information database 230 is moved to the dynamic security code database 220 and replaced with the updated dynamic security code. Thus, the updated dynamic security code is used for future transactions and may be provided to the user in response to future received 401 requests for the current dynamic security code.

### Computing Machine Architecture

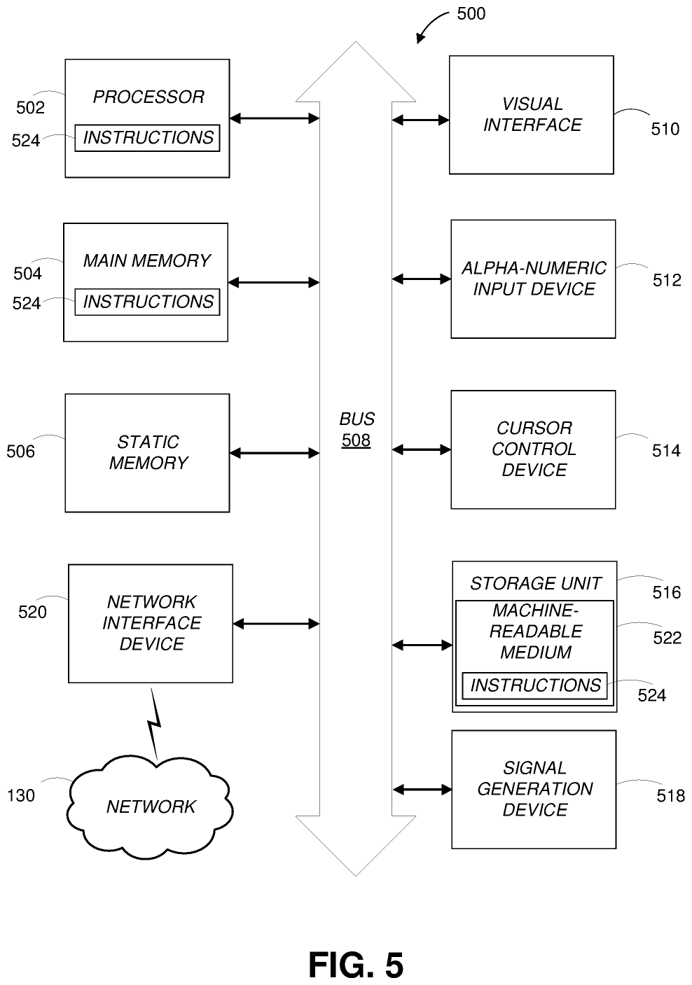

FIG. 5 is a block diagram illustrating components of an example machine able to read instructions from a machine-readable medium and execute them in a processor (or controller). Specifically, FIG. 5 shows a diagrammatic representation of a machine in the example form a computer system 500, within which program code (e.g., software or software modules) for causing the machine to perform any one or more of the methodologies discussed herein may be executed. The program code may be comprised of instructions 524 executable by one or more processors 502. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment or connected to a wide area network (WAN) allowing the system's alerts to be sent via email and text messages.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include visual display interface 510. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 510 may include or may interface with a touch enabled screen. The computer system 500 may also include alphanumeric input device 512 (e.g., a keyboard or touch screen keyboard), a cursor control device 514 (e.g., a mouse, a trackball, a joystick, a motion sensor, or other pointing instrument), a storage unit 516, a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network 130 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but not be limited to, data repositories in the form of solid-state memories, optical media, and magnetic media.

### ADDITIONAL CONSIDERATIONS

The issuer system 110 and the transaction processing system 120 described herein may increase the security of transactions while improving the experience of accessing custom payment information. In particular, the technique for generating dynamic security codes as performed by the issuer system 110 and the transaction processing system 120 determines appropriate times at which to generate the dynamic security codes and how to generate them, respectively.

Updating dynamic security codes at a frequency that is either too fast or too slow may negatively affect the issuer system 100's resource consumption (e.g., processor cycles or network bandwidth) or the security of a user's payment information. Updating dynamic security codes too frequently may consume unnecessary processor cycles generating the codes or unnecessary network bandwidth to communicate the codes (e.g., to the user or for remote server storage). Updating dynamic security codes too infrequently may increase the security risk to users with payment information that thieves may use until it is updated, a duration that is extended as the frequency of update slows. To avoid these problems, the issuer system 110 may determine when the generate an updated dynamic security code after a threshold amount of time has passed. That is, the dynamic security code may be updated at a frequency that does not consume unnecessary hardware resources providing frequently updated codes to the user and does not sacrifice the user's security with infrequent updates to the code. This threshold time may also improve the user's experience verifying the user's payment information. In particular, an unpleasant user experience may result from fast rotation of dynamic security codes (i.e., the codes expire after a short amount of time). This short expiration may cause a user to be fatigued or frustrated due to pressure to use the current dynamic security code before it expires. For example, the user may access a digital wallet to use the current dynamic security code to make a purchase, but if the code expires while the user is submitting the payment information, the user may need to resubmit the information. The issuer system 110 can improve the user's experience through the use of the threshold amount of that is more comfortable to the user while maintaining a relatively up to date rotation of security codes.

The generation of static security codes using static values are not as secure as dynamic security codes generated using dynamic values. For example, once the static values used to generate a static security code are determined by a malicious actor, the static security code has been comprised. By using a dynamic value to generate the dynamic security code, as described herein, the card management module 230 may increase the likelihood that successive, generated dynamic security codes are different from one another. Accordingly, the transaction processing system 120 improves the security of a user's payment information.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for preventing fraud during a transaction, the method comprising:
receiving, from a user device, a request for custom payment information, the custom payment information including a dynamic security code verified for use in transactions;
providing, to the user device, the dynamic security code;
receiving, from a transaction processing system, a provisional authorization decision indicating that a security code provided by the user device to complete the transaction fails to match the dynamic security code;
determining whether the security code is stored within a database of previous dynamic security codes;
determining, responsive to determining that the security code is stored within the database of previous dynamic security codes, a risk score for the transaction; and
providing, to the transaction processing system, a final authorization decision based on the risk score, the final authorization indicating that the transaction is authorized to be completed.

2. The method of claim 1, further comprising retrieving the custom payment information from a database of payment information, wherein the database of payment information includes credit card numbers, respective expiration dates, and current dynamic security codes for use within an online payment system.

3. The method of claim 1, further comprising:
requesting an updated dynamic security code from the transaction processing system;
receiving, from the transaction processing system, the updated dynamic security code; and
storing the updated dynamic security code in a database of dynamic security codes.

4. The method of claim 3, wherein the updated dynamic security code is generated using a timestamp corresponding to a time that the final authorization decision is provided.

5. The method of claim 3, further comprising determining whether a threshold amount of time since the dynamic security code was generated has passed, wherein requesting the updated dynamic security code from the transaction processing system is responsive to determining that the threshold amount of time has passed.

6. The method of claim 5, wherein the threshold amount of time is within a range of 12 to 48 hours.

7. The method of claim 3, wherein requesting the updated dynamic security code from the transaction processing system is responsive to detecting that a system event has occurred.

8. The method of claim 1, further comprising providing, responsive to determining that the record is not stored within the database of dynamic security codes, a fraud notice to at least one of the transaction processing system or the user device.

9. A non-transitory computer readable medium comprising stored instructions for authorizing a transaction, the instructions when executed by at least one processor cause the at least one processor to:
receive, from a merchant device, an authorization request associated with the transaction, the authorization request comprising a security code provided to the merchant device to complete the transaction;
determine a provisional authorization decision indicating that the security code fails to match a dynamic security code verified for use in transactions by an issuer system;
request a final authorization decision of the transaction from the issuer system;
receive, from the issuer system, the final authorization decision indicating that the transaction is authorized to be completed, wherein the final authorization decision is determined based on a determination that the security code is stored within a database of dynamic security codes; and
provide, to the merchant device, the final authorization decision.

10. The non-transitory computer readable medium of claim 9, further comprising instructions that when executed by the at least one processor cause the at least one processor to:
receive, from the issuer system, a security code update request to generate an updated dynamic security code, the updated dynamic security code replacing the dynamic security code for use in a future transaction;
generate, using a timestamp corresponding to a time that the final authorization decision is made, the updated dynamic security code; and
provide, to the issuer system, the updated dynamic security code.

11. The non-transitory computer readable medium of claim 10, wherein generating, based on the timestamp corresponding to the time that the final authorization decision is made, the updated dynamic security code comprises calculating the updated dynamic security code using a hash algorithm, the timestamp, and one or more of a credit card's number and an expiration of the credit card.

12. The non-transitory computer readable medium of claim 9, wherein determining the provisional authorization decision indicating that the security code fails to match the dynamic security code verified for use in transactions by the issuer system comprises:
determining, using custom payment information associated with the security code and an algorithm specified by the issuer system, the dynamic security code; and
determining, responsive to comparing the security code and the second dynamic security code, that the security code and the dynamic security code do not match.

13. The non-transitory computer readable medium of claim 9, wherein requesting the final authorization decision of the transaction from the issuer system comprises transmitting a final authorization request to the issuer system, the final authorization request comprising at least one of a hashed value of the dynamic security code and an indication of whether the security code matches dynamic security code.

14. The non-transitory computer readable medium of claim 9, wherein the dynamic security code is updated after a threshold amount of time has passed.

15. The non-transitory computer readable medium of claim 9, wherein the determination that the security code is stored within the database of dynamic security codes is used to determine a risk score, the final authorization decision determined further based on the risk score.

16. A system for authorizing a transaction, the system comprising:
an issuer system configured to:
receive, from a user device, a request for custom payment information, the custom payment information including a dynamic security code verified for use in transactions,
provide, to the user device, the dynamic security code,
receive, from a transaction processing system, a provisional authorization decision indicating that a security code provided by the user device to complete the transaction fails to match the dynamic security code,
determine whether the security code is stored within a database of previous dynamic security codes,
determine, responsive to determining that the security code is stored within the database of previous dynamic security codes, a risk score for the transaction, and
provide, to the transaction processing system, a final authorization decision based on the risk score, the final authorization indicating that the transaction is authorized to be completed; and
the transaction processing system configured to:
receive, from a merchant device, an authorization request associated with the transaction, the authorization request comprising the security code,
determine the provisional authorization decision indicating that the security code fails to match the dynamic security code,
request the final authorization decision of the transaction from the issuer system;
receive, from the issuer system, the final authorization decision indicating that the transaction is authorized to be completed, and
provide, to the merchant device, the final authorization decision.

17. The system of claim 16, further comprising the merchant system configured to:
receive, from the user device, the security code;
generate the authorization request comprising the security code;
transmit, to the transaction processing system, the authorization request;
receive, from the transaction processing system, the final authorization decision; and
provide, responsive to the final authorization decision indicating that the transaction is authorized to be completed, a confirmation to the user device that the transaction is complete.

18. The system of claim 16, wherein the merchant system is further configured to provide, to the user device and responsive to an alternate final authorization decision indicating that the transaction is unauthorized to be completed, a prompt for entry of an alternate security code.

19. The system of claim 16, further comprising the user device configured to:
transmit, to the issuer system, the request for custom payment information;
receive, from the issuer system, the dynamic security code;
receive the security code, a user entering the security code using an input interface of the user device; and
transmit, to the merchant system, the security code.

20. The system of claim 16, wherein:
the issuer system is further configured to:
request, responsive to determining that a threshold amount of time since the dynamic security code was generated has passed, an updated dynamic security code from the transaction processing system,
receive, from the transaction processing system, the updated dynamic security code, and
store the updated dynamic security code in the database of dynamic security codes; and
the transaction processing system is further configured to:
receive, from the issuer system, a security code update request to generate an updated dynamic security code, the updated dynamic security code replacing the dynamic security code for use in a future transaction,
generate, based on a timestamp corresponding to a time that the final authorization decision is made, the updated dynamic security code, and
provide, to the issuer system, the updated dynamic security code.
